(19) United States
(12) Patent Application Publication
(10) Pub. No.: US 2005/0018851 A1
(43) Pub. Date: Jan. 27, 2005

(54) Methods and apparatuses for providing blind digital signatures using curve-based cryptography

(75) Inventors: Ramarathnam Venkatesan, Redmond, WA (US); Dan Boneh, Palo Alto, CA (US)

Correspondence Address: LEE & HAYES PLLC, 421 W RIVERSIDE AVENUE SUITE 500, SPOKANE, WA, 99201, US

(73) Assignee: MICROSOFT COPRORATION, REDMOND, WA (US)

(21) Appl. No.: 10/609,261

(22) Filed: Jun. 26, 2003

(51) Int. Cl. H04L 9/00

(52) U.S. Cl. 380/277

(57) ABSTRACT

Methods and apparatuses are provided for generating blind digital signatures using curve-based cryptography techniques. One exemplary method includes establishing parameter data for use with signature generating logic that encrypts data based on a Jacobian of at least one curve. Here, the parameter data causes the signature generating logic to select at least one Gap Diffie-Hellman (GDH) group of elements relating to the curve. The method also includes receiving first data that is to be blindly signed, determining private key data and corresponding public key data using the signature generating logic, and generating second data by signing the first data with the private key data using the signature generating logic. The second data includes the corresponding blind digital signature. In other implementations, the method may also include having additional logic, for example, in one or more other devices, determine if the blind digital signature is valid.

### RELATED PATENT APPLICATIONS

This Patent Application is related to co-pending patent application Ser. No. ___/______ (Attorney Docket Number MS1-1043US), titled “Methods And Apparatuses For Providing Short Digital Signatures Using Curve-Based Cryptography”.

### TECHNICAL FIELD

This invention relates to cryptography, and more particularly to cryptography systems, apparatuses and related methods that provide and/or use blind digital signatures based on curve-based cryptography techniques.

### BACKGROUND

As computers have become increasingly commonplace in homes and businesses throughout the world, and such computers have become increasingly interconnected via networks (such as the Internet), security and authentication concerns have become increasingly important. One manner in which these concerns have been addressed is the use of a cryptographic technique involving a key-based cipher. Using a key-based cipher, sequences of intelligible data (typically referred to as plaintext) that collectively form a message are mathematically transformed, through an enciphering process, into seemingly unintelligible data (typically referred to as cipher text). The enciphering can be reversed, allowing recipients of the cipher text with the appropriate key to transform the cipher text back to plaintext, while making it very difficult, if not nearly impossible, for those without the appropriate key from recovering the plaintext.

Public-key cryptographic techniques are one type of key-based cipher. In public-key cryptography, each communicating party has a public/private key pair. The public key of each pair is made publicly available (or at least available to others who are intended to send encrypted communications), but the private key is kept secret. In order to communicate a plaintext message using encryption to a receiving party, an originating party encrypts the plaintext message into a cipher text message using the public key of the receiving party and communicates the cipher text message to the receiving party. Upon receipt of the cipher text message, the receiving party decrypts the message using its secret private key, and thereby recovers the original plaintext message.

The RSA (Rivest-Shamir-Adleman) method is one well-known example of public/private key cryptology. To implement RSA, one generates two large prime numbers p and q and multiplies them together to get a large composite number N, which is made public. If the primes are properly chosen and large enough, it will be practically impossible (i.e., computationally infeasible) for someone who does not know p and q to determine them from just knowing N. New curve-based cryptography techniques are also becoming more common.

One of the benefits to these and other like cryptography techniques is that data can be digitally signed to increase reliability of the communicated data, for example. There are times when it would also be beneficial to have the ability to have one device digitally sign data in a “blind” manner, e.g., without necessarily knowing what the information associated with the data being signed. By way of example, an electronic-commerce customer may desire to have a blind digital signature by their bank on an electronic funds transfer message, or the like.

### SUMMARY

In accordance with certain exemplary implementations of the present invention, a method is provided for generating blind digital signatures in curve-based cryptography systems. The method includes establishing parameter data for use with signature generating logic that encrypts data based on a Jacobian of at least one curve, the parameter data causing the signature generating logic to select at least one Gap Diffie-Hellman (GDH) group of elements relating to the curve. The method also includes receiving first data that is to be blindly signed, determining private key data and corresponding public key data using the signature generating logic, and generating second data by signing the first data with the private key data using the signature generating logic. Here, the second data includes the corresponding blind digital signature. In other implementations, the method may also include having additional logic determine if the blind digital signature is valid.

In accordance with certain other exemplary implementations of the present invention, an apparatus is provided which includes memory and blind signature generating logic. Here, for example, the memory is configured to store first data that is to be signed by blind signature generating logic, which is configured according to parameter data so as to be capable of encrypting data based on a Jacobian of at least one curve, the parameter data causing the blind signature generating logic to select at least one Gap Diffie-Hellman (GDH) group of elements relating to the curve. The logic is further configured to determine private key data and corresponding public key data, and generate second data by signing the first data with the private key data. Here, for example,, the second data includes the corresponding blind digital signature.

### BRIEF DESCRIPTION OF THE DRAWINGS

The present invention is illustrated by way of example and not limitation in the figures of the accompanying drawings. The same numbers are used throughout the figures to reference like components and/or features.

FIG. 1 is a block diagram depicting an exemplary computing environment that is suitable for use with certain implementations of the present invention.

FIG. 2 is a block diagram depicting a cryptographic system in accordance with certain exemplary implementations of the present invention.

FIG. 3 is a flow diagram illustrating an exemplary cryptography process in accordance with certain implementations of the present invention.

### DETAILED DESCRIPTION

Introduction:

In accordance with certain aspects of the present invention curve-based cryptography techniques are provided for use in systems, apparatuses and methods.

Many of these techniques are based on the Computational Diffie-Hellman assumption on certain high genus order (e.g., genus greater than one) hyper elliptic curve groups. The resulting encryption is believed to be at least as strong as that produced by a conventional Digital Signature Algorithm (DSA) for a similar level of security.

Short digital signatures are often used in environments where a user is asked to manually input a digital signature. For example, product registration systems often ask users to key in a digital signature provided on a CD label. More generally, short digital signatures are also useful in low bandwidth communication environments. For example, short digital signatures may be used when printing a digital signature on a postage stamp.

Currently, the two most frequently used digital signatures schemes, RSA and DSA, provide relatively long digital signatures (compared to the security they provide). For example, using a 1024-bit modulus, RSA digital signatures are 1024 bits long. Similarly, using a 1024-bit modulus, standard DSA digital signatures are 320 bits long. Elliptic curve variants of DSA, such as ECDSA, are also 320 bits long. For example see ANSI X9.62 and FIPS 186-2. Elliptic Curve Digital Signature Algorithm, 1998. A 320-bit digital signature may be too long to be keyed in by a user.

Digital signature schemes are provided herein that can be used to produce digital signatures having even shorter lengths, e.g., approximately 160 bits in certain instances, but which provides a similar level of security as longer 320-bit DSA digital signatures. These short digital signature schemes are believed secure against existential forgery under a chosen message attack (in the random oracle model) assuming the Computational Diffie-Hellman (CDH) problem is hard on certain hyper elliptic curves over a finite field. Generating a digital signature, for example, can be as simple as multiplying on the hyper elliptic curve. Verifying the resulting digital signature can be accomplished using a bilinear pairing on the curve.

In accordance with certain aspects of the present invention, the digital signature schemes described herein are further extended to provide blind signatures.

Exemplary Operational Environment:

Turning to the drawings, wherein like reference numerals refer to like elements, the invention is illustrated as being implemented in a suitable computing environment. Although not required, the invention will be described in the general context of computer-executable instructions, such as program modules, being executed by a personal computer.

Generally, program modules include routines, programs, objects, components, data structures, etc. that perform particular tasks or implement particular abstract data types. Those skilled in the art will appreciate that the invention may be practiced with other computer system configurations, including hand-held devices, multi-processor systems, microprocessor based or programmable consumer electronics, network PCs, minicomputers, mainframe computers, portable communication devices, and the like.

The invention may also be practiced in distributed computing environments where tasks are performed by remote processing devices that are linked through a communications network. In a distributed computing environment, program modules may be located in both local and remote memory storage devices.

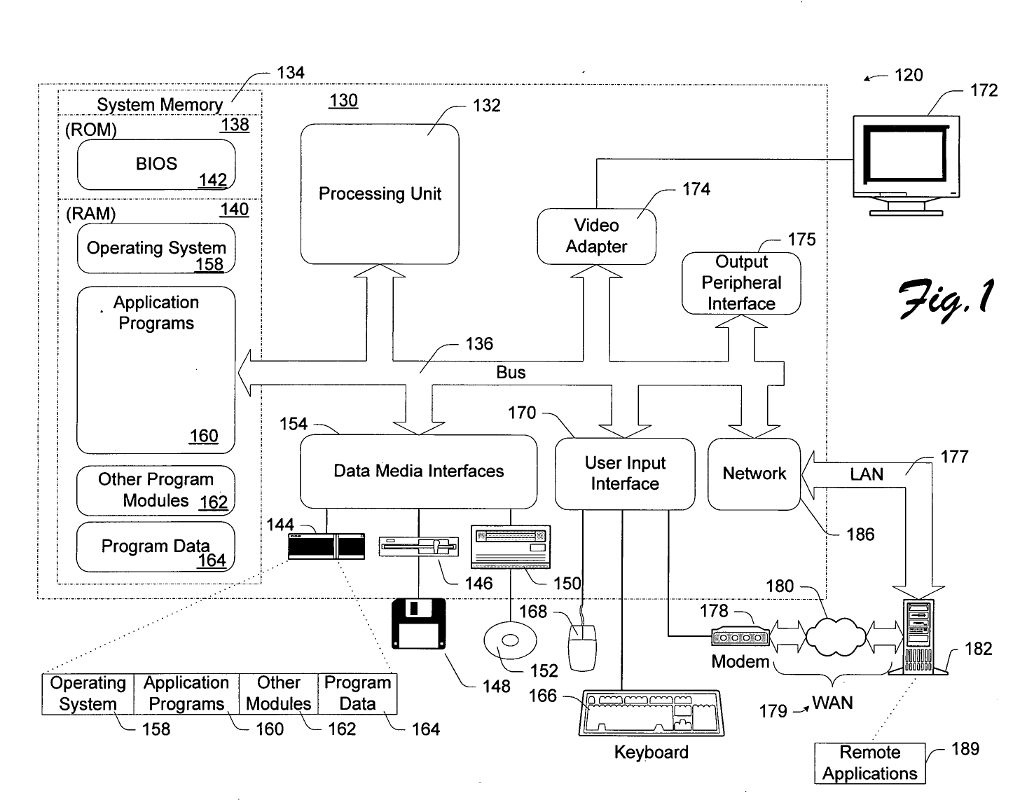

FIG. 1 illustrates an example of a suitable computing environment 120 on which the subsequently described systems, apparatuses and methods may be implemented. Exemplary computing environment 120 is only one example of a suitable computing environment and is not intended to suggest any limitation as to the scope of use or functionality of the improved methods and systems described herein. Neither should computing environment 120 be interpreted as having any dependency or requirement relating to any one or combination of components illustrated in computing environment 120.

The improved methods and systems herein are operational with numerous other general purpose or special purpose computing system environments or configurations. Examples of well known computing systems, environments, and/or configurations that may be suitable include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

As shown in FIG. 1, computing environment 120 includes a general-purpose computing device in the form of a computer 130. The components of computer 130 may include one or more processors or processing units 132, a system memory 134, and a bus 136 that couples various system components including system memory 134 to processor 132.

Bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus also known as Mezzanine bus.

Computer 130 typically includes a variety of computer readable media. Such media may be any available media that is accessible by computer 130, and it includes both volatile and non-volatile media, removable and non-removable media.

In FIG. 1, system memory 134 includes computer readable media in the form of volatile memory, such as random access memory (RAM) 140, and/or non-volatile memory, such as read only memory (ROM) 138. A basic input/output system (BIOS) 142, containing the basic routines that help to transfer information between elements within computer 130, such as during start-up, is stored in ROM 138. RAM 140 typically contains data and/or program modules that are immediately accessible to and/or presently being operated on by processor 132.

Computer 130 may further include other removable/non-removable, volatile/non-volatile computer storage media. For example, FIG. 1 illustrates a hard disk drive 144 for reading from and writing to a non-removable, non-volatile magnetic media (not shown and typically called a “hard drive”), a magnetic disk drive 146 for reading from and writing to a removable, non-volatile magnetic disk 148 (e.g., a “floppy disk”), and an optical disk drive 150 for reading from or writing to a removable, non-volatile optical disk 152 such as a CD-ROM/R/RW, DVD-ROM/R/RW/+R/RAM or other optical media. Hard disk drive 144, magnetic disk drive 146 and optical disk drive 150 are each connected to bus 136 by one or more interfaces 154.

The drives and associated computer-readable media provide nonvolatile storage of computer readable instructions, data structures, program modules, and other data for computer 130. Although the exemplary environment described herein employs a hard disk, a removable magnetic disk 148 and a removable optical disk 152, it should be appreciated by those skilled in the art that other types of computer readable media which can store data that is accessible by a computer, such as magnetic cassettes, flash memory cards, digital video disks, random access memories (RAMs), read only memories (ROM), and the like, may also be used in the exemplary operating environment.

A number of program modules may be stored on the hard disk, magnetic disk 148, optical disk 152, ROM 138, or RAM 140, including, e.g., an operating system 158, one or more application programs 160, other program modules 162, and program data 164.

The improved methods and systems described herein may be implemented within operating system 158, one or more application programs 160, other program modules 162, and/or program data 164.

A user may provide commands and information into computer 130 through input devices such as keyboard 166 and pointing device 168 (such as a “mouse”). Other input devices (not shown) may include a microphone, joystick, game pad, satellite dish, serial port, scanner, camera, etc. These and other input devices are connected to the processing unit 132 through a user input interface 170 that is coupled to bus 136, but may be connected by other interface and bus structures, such as a parallel port, game port, or a universal serial bus (USB).

A monitor 172 or other type of display device is also connected to bus 136 via an interface, such as a video adapter 174. In addition to monitor 172, personal computers typically include other peripheral output devices (not shown), such as speakers and printers, which may be connected through output peripheral interface 175.

Computer 130 may operate in a networked environment using logical connections to one or more remote computers, such as a remote computer 182. Remote computer 182 may include many or all of the elements and features described herein relative to computer 130.

Logical connections shown in FIG. 1 are a local area network (LAN) 177 and a general wide area network (WAN) 179. Such networking environments are commonplace in offices, enterprise-wide computer networks, intranets, and the Internet.

When used in a LAN networking environment, computer 130 is connected to LAN 177 via network interface or adapter 186. When used in a WAN networking environment, the computer typically includes a modem 178 or other means for establishing communications over WAN 179. Modem 178, which may be internal or external, may be connected to system bus 136 via the user input interface 170 or other appropriate mechanism.

Depicted in FIG. 1, is a specific implementation of a WAN via the Internet. Here, computer 130 employs modem 178 to establish communications with at least one remote computer 182 via the Internet 180.

In a networked environment, program modules depicted relative to computer 130, or portions thereof, may be stored in a remote memory storage device. Thus, e.g., as depicted in FIG. 1, remote application programs 189 may reside on a memory device of remote computer 182. It will be appreciated that the network connections shown and described are exemplary and other means of establishing a communications link between the computers may be used.

Exemplary System and Apparatuses:

The description that follows assumes a basic understanding of cryptography by the reader. For a basic introduction of cryptography, the reader is directed to “Applied Cryptography: Protocols, Algorithms, and Source Code in C,” Second Edition, written by Bruce Schneier and published by John Wiley & Sons in 1996, and which is incorporated herein by reference in its entirety.

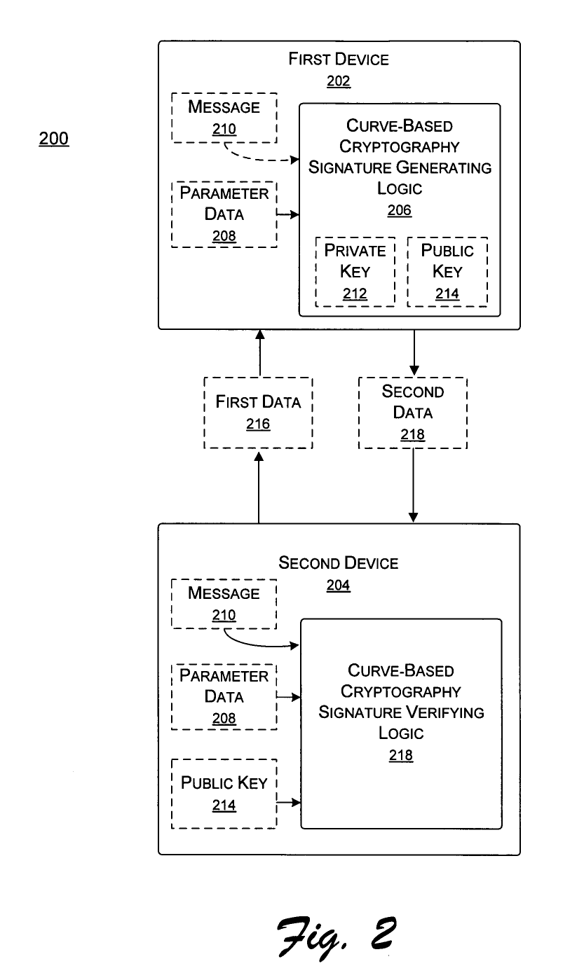

Attention is now directed to FIG. 2, which is a block diagram of a system 200 that provides for short digital signature operations and blind digital signature operations, in accordance with certain exemplary implementations of the present invention.

System 200 includes a first device 202 that is configured to generate a short/blind digital signature that can then be provided to a second device 204 and verified. First device 202 includes curve-based cryptography signature generating logic 206, which is configured according to parameter data 208. Once configured logic 206 if used to generate a short digital signature, then logic 206 takes message data 210, for example, containing licensing information, etc., and generates a corresponding digital signature that can provided to second device 204. The short digital signature is generated based on the curve-based encrypting techniques provided herein, which include generating a secret/signing or private key 212 and a corresponding public key 214.

For short digital signatures, then, the digital signature can be then provided, e.g., communicated, input, etc., to curve-based cryptography signature verifying logic 218 within second device 204. Here, logic 218 can also be provided with message data 210, parameter data 208, and public key 214. Logic 218 then verifies digital signature 216 in accord with the verification schemes described herein. Thus, for example, logic 206 and 218 can be configured to support GDH digital signature schemes, while in other implementations they are configured to support a modified (co-gap) digital signature scheme. These schemes are described in greater detail below.

In accordance with certain aspects of the present invention, system 200 may also provide blind digital signature capabilities. Thus, for example, first device 202 can be configured to generate private key data 212 and public key data 214. Here, second device 204 may then request that curve-based cryptography signature generating logic 206 in first device 202 provide a blind signature. Thus, curve-based cryptography signature verifying logic 218 may hash message data 210 and further process the results to create first data 216, which is provided to first device 202. Note that in this blind signature example, first device 202 need not know message data 210. Logic 206 in first device 202 would then signs first data 216 to produce second data 218, which having been blindly signed is provided to second device 204. Curve-based cryptography signature verifying logic 218 in second device 204, then verifies that the blind signature is correct.

Additional details into various short and blind digital signature schemes are provided in subsequent sections.

Exemplary Blind Signature Process:

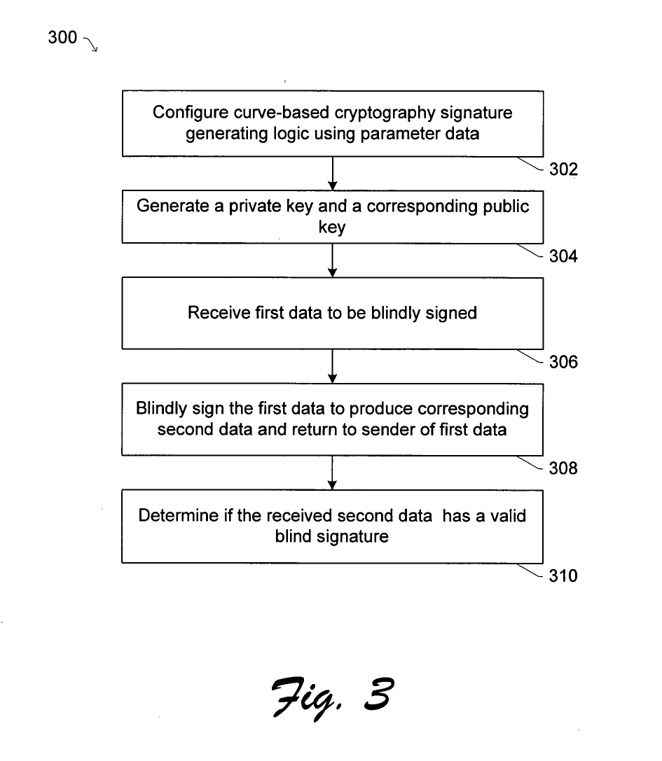

Attention is now drawn to FIG. 3, which is a flow diagram depicting a blind digital signature operation process 300, in accordance with certain exemplary implementations of the present invention. As with the block diagrams in FIGS. 1 and 2, the flow diagram in FIG. 3 is configured to support/implement curve-based short/blind digital signature processes for curves as described herein.

In act 302, curve-based cryptography signature generating logic is configured using parameter data. In act 304, a private key and a corresponding public key are generated using the curve-based cryptography signature generating logic. Then, in act 306, a first data is received by the curve-based cryptography signature generating logic. In act 308, the curve-based cryptography signature generating logic signs the first data to produce corresponding second data, which is then provided back to the sender of the first data. In act 310, the second data is processed to determine if the blind signature is valid.

Exemplary Short Signature Schemes:

Some curve-based cryptography schemes with regard to short signatures are described in this section, to provide additional information about the blind signature techniques for use in the exemplary systems, apparatuses and methods as described above, and others like them.

Defining Gap-Diffie-Hellman Groups:

Short digital signature schemes are provided that work in any Gap Diffie-Hellman (GDH) group (which is written multiplicatively when defined over the set of integers modulo a prime and written additively when the group is defined by the points on an elliptic curve or a Jacobian), as defined below, for example. These new constructions are based on giving new gap Diffie-Hellman groups.

Consider a (multiplicative) cyclic group G=<g>, with p=|G| a prime. There three problems of interest on G, namely Group Action, Decision Diffie-Hellman and Computational Diffie-Hellman.

Group Action:
Given u, v∈G, find uv.

Decision Diffie-Hellman:
For a, b, c∈Z^{*}ₚ, given g^{a}, g^{b}, and g^{c}, decide whether c=ab.

Computational Diffie-Hellman (CDH):
For a, b∈Z^{*}ₚ, given g^{a} and g^{b} compute g^{ab}.

A Gap Diffie-Hellman (GDH) group can be defined in stages:

Let G be a τ-decision group for Diffie-Hellman if the group action can be computed in one time unit, and Decision Diffie-Hellman can be computed in time at most τ.

Let the advantage of an algorithm A in solving the Computational Diffie-Hellman problem in a group G be:

$$AdvCDH {=}^{def} Pr [ A ( g , {g}^{a} , {g}^{b} ) = {g}^{ab} : a , b {←}^{R} ] {Z}_{p}^{*}$$

Where the probability is over the choice of a and b, and the coin tosses of A. Thus, one can state that an algorithm A(τ,ε)-GDH breaks Computational Diffie-Hellman in G if A runs in time at most τ, and AdvCDH_{A}≧ε.

A prime order group G is a (τ, t, ε)-GDH group if it is a τ-decision group for Diffie-Hellman and no algorithm (t, ε) breaks Computational Diffie-Hellman on it.

GDH Digital Signature Schemes:

An exemplary GDH digital signature scheme allows the creation of digital signatures on arbitrary messages m∈{0, 1}*. Here, a digital signature σ is an element of G. The base group G and the generator g are system parameters (e.g., included in parameter data 208 (FIG. 2)).

The digital signature scheme includes three basic algorithms, namely a key generation algorithm, a signing algorithm, and verifying algorithm. In certain implementations, the digital signature scheme makes use of a full-domain hash function h: {0, 1}*→G. In other implementations, for example as described in subsequent sections herein, the requirement on the full-domain hash may be weakened.

Key Generation:

Pick

$$x {←}^{R} {Z}_{p}^{*} ,$$

and compute v←g^{x}. Here, the public key is v; the secret key is x.

Signing:

Given a secret key x, and a message m∈{0, 1}*, compute h←h(m), and σ←h^{x}. The digital signature is τ.

Verification:

Given a public key v, a message m, and a digital signature σ. Compute h←h(m). Verify that (g, v, h, σ) is a valid Diffie-Hellman tuple.

Note that a GDH digital signature is a single element of G. Hence, to construct short digital signatures preferably the GDH group includes elements having short representations.

Extending the Signature Scheme to Use “Unreliable” Hashing:

The exemplary schemes presented above assume the existence of a hash function h that maps uniformly from arbitrary strings to elements of the GDH group. Such a function may not always be practical and/or immediately available. For example, hashing onto a subgroup of an elliptic curve over a finite field requires some care in order to maintain the proof of security. More generally, it is possible that one only has an unreliable hash function h′: {0, 1}*→G∪{⊥} For a given message m∈{0, 1}*. the hash function h′ outputs either an element of G, or ⊥ (the later indicating a failure). For example, let h be an auxiliary hash function mapping messages in {0, 1 }* onto Fₚ. Then h(m) outputs failure if h(m) is not an x-coordinate of any point in E/Fₚ. Otherwise h′(m) outputs one of the points whose x-coordinate is h(m). In the security analysis one may view h as a random oracle.

Let B⊂A be two finite sets with |B|=|G|. An “unreliable” hash function h′ is a composition of two functions: h(m)=ƒ(h(m)), where h:{0, 1}*→A. For x∉B we have ƒ(x)=⊥. For x∈B the function ƒ is one-to-one onto G. We say that h′ is η-unreliable if |B|/|A|=η.

Note that for any m, an η-unreliable hash function h′ satisfies h′(mεG with probability 1−η (over the choice of the random oracle h). As an example of unreliable hashing consider hashing onto an elliptic curve E: y²=g(x)/Fₚ. The set A can be the field Fₚ×{0, 1}, and B can be the set of points x∈A for which g(x) is a quadratic residue in Fₚ.

An η-unreliable hash function h′ can be used to construct a reliable hash is function h onto G. Fix a small parameter I=[log₂log_{1-η}δ], where δ is a desired bound on the probability of failure.

For any i∈{0, . . . , 2I-1}, let xᵢ be the output of h(i∥m), where I is represented as an I-bit string. Find i*, the smallest i for which xᵢ=⊥. The hash h(m) of a message m is defined to be xᵢ.

For each i, the probability that xᵢ is a point on G is η, so the expectation on calls to h′ is 1/η, and the probability that a message m will be found unhashable is (1−η)²^{^{l}}≦δ. Note, also, that h′ is collision-resistant if h′ is, since a collision on h necessarily exposes a collision on h′.

Given an unreliable hash function h′, and an integer I as parameters, one may define the algorithm MapToGroup, which maps arbitrary input strings onto G with overwhelming probability. An exemplary algorithm works as follows:

(1) given x∈{0, 1}*, set i←0,

(2) set y←h′(I∥x),

(3) if y≠⊥, return y,

(4) otherwise, increment i and goto step (2),

(5) if i reaches 2^{I}, report failure.

The failure probability may be made arbitrarily small by picking an appropriately large I, as above.

Other Short Digital Signature Schemes Using More General Curves Having a Genus Greater than or Equal to One:

Here, it is shown that super-singular curves of genus 2 or 3, for example, may be used to obtain short digital signatures. Although these curves do not give GDH group as described above, they and others like them may still be used to provide beneficial short digital signatures. Here, for example, one important tool that can be used is Weil pairing on the Jacobian of these curves.

Let E/Fₚ^{l} be an algebraic curve of genus g=2 or g=3 and let J be its Jacobian. Let P, Q∈J be linearly independent points of order q. Assume P∈J/Fₚ_{^{l}} and Q∈J/Fₚ_{^{la}}. Using the Weil pairing in J it is easy to decide if a given tuple (P, aP, Q, bQ) satisfies a=b. This is referred to herein as the co-Decision Diffie-Hellman problem, and it has an obvious computational variant: given the tuple (P, Q, aQ), compute aP. Thus, one can modify the GDH digital signature scheme to work in such groups. An exemplary modified (co-gap) digital signature scheme is as follows:

Key Generation:

Pick

$$x {←}^{R} {Z}_{q}^{*} ,$$

and compute R←xQ. The public key is R; the secret key is x.

Signing:

Given a secret key x, and a message m∈{0, 1}*, compute Pₘ←h(m)∈J/Fₚ_{^{l}}, and Sₘ←xPₘ. The digital signature σ is the x-coordinate of the g points in the representation of Sₘ as a reduced divisor.

Verification:

Given a public key R, a message m, and a purported digital signature σ, let S be a point on J/Fₚ_{^{l}} whose x-coordinates is in σ and whose y-coordinate is y for some y∈Fₚ_{^{l}} (if no such point exists reject the digital signature as invalid). Set U←e(P,S) and v←e(R, φ(h(m))). If u=v accept the digital signature, otherwise reject it.

The tests in the verification phase ensure that either (P, R, h(m), S) or (P, R, h(m), −S) is a valid co-Diffie-Hellman tuple. While the public key, R, is an element of E/Fₚ_{^{la}}, and thus long, a digital signature σ is an element of E/Fₚ_{^{l}}, and thus relatively short.

In certain instances, the verification algorithm may not be entirely complete. Here, for example, if the digital signature does not contain the y-coordinates then one will need to recompute them when verifying the digital signature. However, there are two possible values for the y coordinate. On a curve of genus g this means that there are ₂^{g} possibilities for S (in the verification algorithm). So, one would need to test whether any of these ₂^{g} candidates are a valid digital signature.

The security of such schemes follows from the assumption that no adversary can efficiently break the co-Computational Diffie-Hellman problem. In certain exemplary implementations, super singular curves of genus 2 and 3 have been constructed.

First, a necessary condition for CDH intractability on a subgroup of J is characterized.

Let p be a prime, l a positive exponent, and J a Jacobian of some curve over Fₚ_{^{l}} with m points, where m is a small multiple of a prime. Then J has a security multiplier α, for some integer α>0, if the order of p^{l} in F^{*}ₘ is α.

In other words:
m|p^{la}−1 and mp^{lk}−1 for all k=1,2, . . . ,α−1

For a large prime q dividing m, so that:
q²m

the Jacobian J has a security multiplier α_{q} for q if the order of p^{l} in F^{*}_{q} is α_{q}.

By necessity, α_{q} divides α for all curves. For a point P on J, with order q, the security parameter α_{q} bounds from below the size of fields into which (P) can be mapped. Consider any nontrivial homomorphism from (P) into a subgroup A of F^{*}ₚ_{^{li}}. Then q divides |A|, and |A| divides |Fₚ_{ⁱ}|=p^{li}−1. Thus q|p^{li}−1, so i≧α_{q}.

Let J be the Jacobian of this curve. This curve of genus 2 has security multiplier α=12. The advantage in using the higher genus curves is that the security multipliers can be higher. Hence, one needs to find values of l for which the number of points on J/F₂_{^{l}} is a small multiple of a prime. Let m(l) be the number of points on J/F₂_{^{l}}. Here, it is known that m(l) is an integer of length 2l bits. For l=43 one can show that m(l) is a small multiple of a prime. Hence, for l=43 one gets a digital signature of length 86 bits where breaking the scheme requires the computation of a discrete log on a subgroup of J/F₂_{⁴³} of size approximately 2⁸⁶. Furthermore, when using the Weil pairing to reduce the discrete log problem to a finite field, one obtains a discrete log problem in the group F₂_{¹²⁺⁴³}=F^{*}₂_{⁵¹⁶}.

Let q be the largest prime factor of m(43). Then J/F₂_{⁴³} contains a point P of order q. The open problem now is to prove that J/F₂_{⁵¹⁶} contains a point Q of order q which is linearly independent of P. This is needed for verifying digital signatures and is guaranteed to exist by Tate-Honda theory. It is also noted that in certain implementations, for example, to get α=30 one might use Abelian varieties that are not Jacobians of curves.

Thus, short digital signature schemes have been presented based on super singular hyperelliptic curves, for example. The length of the resulting digital signature is one element in the Jacobian of the curve. By comparison, standard digital signatures based on discrete log such as DSA typically require two elements.

Exemplary Blind Digital Signatures:

With the above short signature schemes in mind, it is further provided herein that any Gap Diffie-Hellman Group further provides a new mechanism for blind digital signatures. See also, e.g., D. Chaum, Blind Signatures for Untraceable Payments, Proceedings of Crypto 1982, Plenum Press, pp. 199-203.

Let G be a GDH group of order p and let g be a generator of G. An exemplary blind digital signature scheme works as follows:

Key Generation:

Pick

$$x {←}^{R} {Z}_{p}^{*} ,$$

and compute v←g^{x}. The public key is v; the private (signing) key is x.

Generating a Blind Signature:

With reference to FIG. 2, in order to sign a message m∈{0, 1}*, for example, logic 218 in second device 204 computes h=h(m)∈G. Here, logic 218 then picks a random r∈Z*ₚ and sets h′=r·h∈G. Second device 204 sends h′ to the signer, e.g., within first data 216.

The signer, in this case logic 206 in first device 202, receives first data 216 and signs h′ by computing σ′=x·h′∈G.

Next, first device 202 sends h′ back to second device 204, e.g., within second data 218. Then, logic 218 obtains a GDH signature on h by computing σ=r·σ′∈G where r′=r⁻¹ mod p. Note that σ=x·h∈G is a valid GDH signature on m.

Verification:

Here, logic 218 in second device 204 has public key v, a message m, and signature σ. From this information, logic 218 can compute h←h(m) and then verify that (g, v, h, σ) is a valid Diffie-Hellman tuple.

The signature scheme above is as secure as the GDH short signature schemes described above because of the similar verification algorithms. Furthermore, when generating the blind signature one will note that given the signer's view, the message h′ (sent from second device 204 to first device 202) the signer is independent of the message m being signed. Hence, the signer obtains no information about the message being signed. Therefore, the above mechanism provides for a secure blind signature.

Conclusion

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
receiving first data to be blindly signed;
establishing parameter data for use with signature generating logic that encrypts data based on a Jacobian of at least one curve, said parameter data causing said signature generating logic to select at least one Gap Diffie-Hellman (GDH) group of elements relating to said curve;
determining private key data and corresponding public key data using said signature generating logic; and
generating second data by signing said first data with said private key data using said signature generating logic, said second data having a corresponding blind digital signature.

2. The method as recited in claim 1, further comprising generating said first data by:
digitally signing a message m∈{0, 1}*,
determining h=h(m)∈G,
selecting a random r∈Z*ₚ and
setting h′=r·h′∈G, wherein said first data includes h′.

3. The method as recited in claim 2, wherein said parameter data establishes a base group G of order p and generator g as system parameters for said signature generating logic.

4. The method as recited in claim 3, wherein determining said private key data and said public key data includes:
picking
$$x {←}^{R} {Z}_{p}^{*} ,$$
and
computing v←g^{x}, wherein said public key data includes v and said private key data includes x.

5. The method as recited in claim 4, wherein generating second data by signing said first data further includes:
signing h′ by computing σ′=x·h′∈G.

6. The method as recited in claim 5, further comprising:
determining if said blind digital signature is valid.

7. The method as recited in claim 6, wherein determining if said blind digital signature is valid further includes:
obtaining a GDH signature on h by computing σ=r·σ′∈G where r′=r⁻¹
mod p and σ=x·h∈G is a valid GDH signature on m; and determining if (g, v, h, σ) is a valid Diffie-Hellman tuple

8. A computer-readable medium having computer-implementable instructions for performing acts comprising:
receiving first data to be blindly signed;
configuring signature generating logic using parameter data so as to be capable of encrypting data based on a Jacobian of at least one curve, said parameter data causing said signature generating logic to select at least one Gap Diffie-Hellman (GDH) group of elements relating to said curve;
determining private key data and corresponding public key data using said signature generating logic; and
generating second data by signing said first data with said private key data using said signature generating logic, said second data having a corresponding blind digital signature.

9. The computer-readable medium as recited in claim 8 having computer-implementable instructions for performing further acts comprising:
generating said first data by digitally signing a message m∈{0, 1}*, determining h=h(m)∈G, selecting a random r∈Z*ₚ and setting h′=r·h′∈G, wherein said first data includes h′.

10. The computer-readable medium as recited in claim 9, wherein said parameter data establishes a base group G of order p and generator g as system parameters for said signature generating logic.

11. The computer-readable medium as recited in claim 10, wherein determining said private key data and said public key data further includes:
picking
$$x {←}^{R} {Z}_{p}^{*} ,$$
and
computing v←g^{x}, wherein said public key data includes v and said private key data includes x.

12. The computer-readable medium as recited in claim 11, wherein generating second data by signing said first data further includes:
signing h′ by computing σ′=x·h′∈G.

13. The computer-readable medium as recited in claim 12, having computer-implementable instructions for performing further acts comprising:
determining if said blind digital signature is valid.

14. The method as recited in claim 13, wherein determining if said blind digital signature is valid further includes:
obtaining a GDH signature on h by computing σ=r·σ′∈G where r′=r⁻¹
mod p and σ=x·h∈G is a valid GDH signature on m; and
determining if (g, v, h, σ) is a valid Diffie-Hellman tuple

15. An apparatus comprising:
memory configured to store first data that is to be blindly signed; and
signature generating logic operatively coupled to said memory and configured according to parameter data so as to be capable of encrypting data based on a Jacobian of at least one curve, said parameter data causing said signature generating logic to select at least one Gap Diffie-Hellman (GDH) group of elements relating to said curve, determine private key data and corresponding public key data, and generate second data by signing said first data with said private key data, said second data having a corresponding blind digital signature.

16. The apparatus as recited in claim 15 wherein said first data is generated by a second logic operatively coupled to said first logic by digitally signing a message m∈{0, 1}*, determining h=h(m)∈G, selecting a random r∈Z^{*}ₚ and setting h′=r·h′∈G, wherein said first data includes h′.

17. The apparatus as recited in claim 16, wherein said parameter data establishes a base group G of order p and generator g as system parameters for said signature generating logic.

18. The apparatus as recited in claim 17, wherein said signature generating logic is further configured to determine said private key data and said public key data by picking
$$x {←}^{R} {Z}_{p}^{*} ,$$
and computing v←g^{x}, wherein said public key data includes v and said private key data includes x.

19. The apparatus as recited in claim 18, wherein said signature generating logic is further configured to generate said second data by signing h′ and computing σ′=x·h′∈G.

20. The apparatus as recited in claim 15, wherein said memory and said signature generating logic are provided within a computing device.
